(19) United States
(12) Patent Application Publication
(10) Pub. No.: US 2008/0249847 A1
(43) Pub. Date: Oct. 9, 2008

(54) GUEST REGISTRATION SYSTEM

(75) Inventor: Thomas Dahlin, Stenungsund (SE)

Correspondence Address: NOVAK DRUCE AND QUIGG LLP (Volvo), 1000 LOUISIANA STREET, FIFTY-THIRD FLOOR, HOUSTON, TX, 77002, US

(73) Assignee: PROMOSCAN, Stenungsund (SE)

(21) Appl. No.: 11/161,507

(22) Filed: Aug. 5, 2005

Related U.S. Application Data
(63) Continuation of application No. PCT/SE04/00168, filed on Feb. 9, 2004.

(30) Foreign Application Priority Data
Feb. 7, 2003 (SE) 0300337-3

(51) Int. Cl. G06Q 30/00

(52) U.S. Cl. 705/14; 705/34

(57) ABSTRACT

Method and arrangement for providing a registration system, preferably for simplifying the checking out procedure for a guest visiting a location, such as a hotel facility. The system includes at least one registration terminal, a communication interface for communication with the guest and a reading device, for reading an information carrier corresponding to a key-information. The system also includes a communication arrangement, for communication with a booking system a compiling arrangement, for compiling a bill with information from the booking system, and a transaction means. The system further includes an information arrangement for providing bill information to the guest and obtaining possible information from the guest for revising the bill with regard to the information from the guest.

### CROSS-REFERENCE TO RELATED APPLICATIONS

The present application is a continuation patent application of International Application No. PCT/SE2004/000168 filed 9 Feb. 2004 which was published in English pursuant to Article 21(2) of the Patent Cooperation Treaty, and which claims priority to Swedish Application No. 0300337-3 filed 7 Feb. 2003. Said applications are expressly incorporated herein by reference in their entireties.

### TECHNICAL FIELD

The present invention relates to a guest registration system, preferably for checking out a person visiting a location. The system comprises at least one registration terminal, a communication interface for communication with the guest and a reading device, for reading an information carrier corresponding to a key-information.

### BACKGROUND OF THE INVENTION

A well-known problem for many hotels is the checking out procedure. Particularly in the mornings of weekdays between 07.00 and 09.00 a.m., the checking out procedure often causes long queues and irritation among the guests. Different systems have developed through the years to solve this problem.

International Patent Publication, WO 01/63425, describes a booking system for hotel rooms comprising a check-out function and a payment service. The system according to this document is characterized in that the system comprises a plurality of appropriately adapted mobile terminals, each such mobile terminal including a short-range wireless device and a long or medium range mobile telephone. The system further comprises, among other units, a processing unit operating with wireless application programs and network communication means. The disadvantages of the system described in WO 01/63425 are that it presupposes that the guest has a mobile telephone to be able to use the system. The guest has to make a reservation and check-in with his/her mobile phone to be able to check-out via the mobile phone according to the system. Other disadvantages of the system are that the guest does not receive a written bill or receipt and that the system can not handle loyalty programs, like loyalty points.

WO 93/12495 describes a guest registration apparatus and method for a guest having a valid general-purpose credit card to register at the place of lodging. The credit card is used as a room key and is also used when checking out from the hotel. The disadvantage of the system described in WO 93/12495 is that it presupposes payment in advance, which results in that no additional costs can be added to the bill afterwards, for example if the guest has used the minibar, restaurant, or the like. This is not a simple problem to be solved. It has been shown that queues at checkout time usually depend on the examination of the bill, including adding or deleting different items. Thus, it is an advantage to eliminate this moment or reduce the time spent at the reception desk. Another disadvantage of the system is that the hotel has to reserve a number of rooms for the users of the system. If all these rooms are occupied, no more guests can use the system. Yet another disadvantage is that the system cannot handle loyalty programs, like loyalty points.

WO 98/43195 describes a computer system comprising a checking out unit comprising an account card reader. When the guest checks-out, the account card reader is used to sum up and calculate the entire costs for charging to the corresponding account. The disadvantage of the system described in WO 98/43195 is that it presupposes payment in advance, which results in that no further costs can be added to the bill afterwards if the guest, for example, has used the minibar, restaurant, hotel garage or the like. Another disadvantage of the system is that the hotel has to reserve a number of rooms for the system. If all these rooms are occupied nobody else can use the system. Yet another disadvantage, as above, is that the system cannot handle loyalty programs, like loyalty points.

### SUMMARY OF THE INVENTION

Among others, advantages of the present invention include: (i) the guest does not need to check-out via the hotel reception; (ii) long guest queues at reception are avoided; (iii) the guest can accept the final bill with all costs included, (both fixed costs and added costs related to the bill information obtained from the guest); (iv) the guest receives a print out of the bill; (v) the guest approves to the bill, either by manual signature on, e.g. a touch screen or “electronic approval”; (vi) all rooms of the location can be included in the system; (vii) the system can handle loyalty programs and, for example, enter loyalty points in a bonus scheme (viii) the system increases the service and reduces the staff costs; and (ix) it is possible to split the bill, for example private expenses and business/company expenses.

For these reasons, the initially mentioned system comprises a communication arrangement, for communication with a booking system, a compiling arrangement for compiling a bill with information from the booking system and a transaction means. The system further comprises an information arrangement for providing bill information to the guest and obtaining possible information from the guest for revising the bill with regard to the information from the guest.

### BRIEF DESCRIPTION OF THE DRAWINGS

In the following the inventions is described in a non-limiting way with reference to a preferred embodiment of the invention, in conjunction with the accompanying drawings, in which:

FIG. 1 is a block diagram of a system configured according to the present invention; and

FIG. 2 is a lateral, cross-sectional view of a registration terminal configured according to preferred embodiment of the present invention.

### DETAILED DESCRIPTION

In the following, one preferred embodiment of the invention and some variations thereof, will be described in detail and with reference to the enclosed drawings.

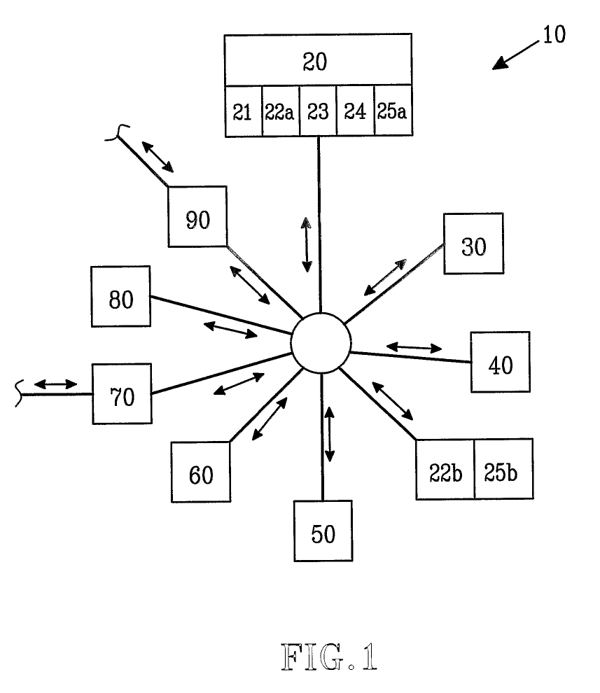

The guest registration system, denoted as 10 in FIG. 1, is an intelligent system and according to one preferred embodiment of the present invention, it is web based and comprises (includes, but is not necessarily limited to): (i) one or several registration terminals 20; (ii) a communication interface 30, for communication with a guest; (iii) a reading device 22b, for reading an information carrier corresponding to a key information; (iv) a communication arrangement 40, for communication with a booking system 50 of the location. The location is for example a hotel, a cruise liner, a golf club or the like; (v) a compiling arrangement 60, for compiling a bill, with information from the booking system 50; (vi) a transaction means 70; (vii) an information arrangement 80, for providing bill information, to the guest; (viii) means for obtaining possible information from the guest and means for changing the bill with regard to the information from the guest; and (ix) a registration arrangement 90, for registration of loyalty points in a loyalty program.

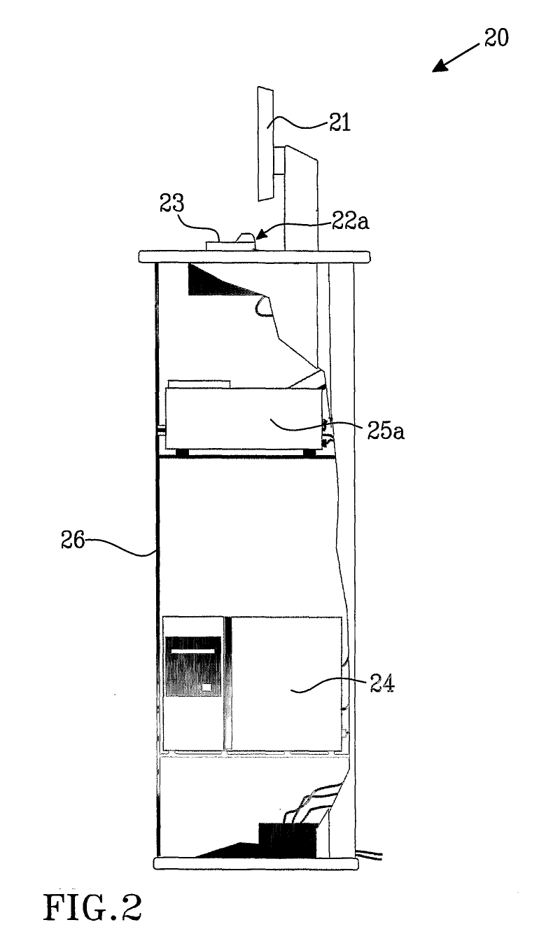

The registration terminal 20 in the preferred embodiment of the invention is a stand-alone checking (out) terminal as exemplarily illustrated in FIG. 2. The terminal 20 comprises a monitor 21, preferably a touch screen, a reading device 22a, preferably a card reader having a magnetic part and a memory part reader. The reading device 22a can also be a biometric sensor for fingerprints and/or facial recognition. The terminal further comprises a key pad 23, a computer 24 preferably an ordinary PC, and a printer 25a. All parts included are enclosed in a housing 26, see FIG. 2.

Several registration terminals 20 can be connected to the system 10. The registration terminals 20 can be placed anywhere in the hotel, for example on each hotel floor, at the hotel reception or in connection with the elevators. The registration terminals 20 can also be placed in the elevators or in the hotel garage, or the like.

The system 10 presupposes that information about the guest has been registered when the guest checks in or makes a booking. In a preferred embodiment, the guest has to check in via the reception. In the reception of the hotel, the reading device 22b is arranged to read a card corresponding to a key-information, important information about the guest. The card can be any of a credit card or a bonus card, or the like. Instead of a card, the biometric signatures of a person, such as fingerprint and/or facial recognition may also be used to register the guest. The key card and the bonus card may for example be combined in one common card, i.e., the same card number is used for both purposes. The common card can, for example, be a credit card, or the like. The reading devices 22a and 22b have the same function but 22a is arranged in the registration terminal 20, and 22b is arranged in the reception of the hotel. A printer 25b is also arranged in the reception and is connected to the registration terminal 20.

The registration terminal 20 communicates with the booking system 50 of the hotel via the communication arrangement 40. The booking system 50 also communicates with the system handling the transactions of the hotel, particularly the credit card transactions, via the transaction means 70. Via the transactions means 70, the system 10 and the company exchanges information about the bills and the transactions.

The registration arrangement 90 is arranged for registration of loyalty points in a loyalty program. The loyalty points provide rewards, such as discount coupons and different offers, like free nights, late checkout and the like. The loyalty program of the hotel is handled by a company that leases database space to the hotel. The hotel communicates with the company via the registration arrangement 90. One benefit of the invention is that it may use a database, which registers the loyalty point irrespective of which type of card the guest uses, as long as the connection between the used card and a loyalty service is established. This may be achieved by using a database including different card numbers of the user and thus connecting the different numbers to a loyalty program.

According to one preferred embodiment of the present invention, the same system handles the transactions and the loyalty program database.

When checking in, the guest arrives at the hotel and checks in the traditional way at the reception desk. The reception clerk inserts the guest's credit card or debit card to register the guest in the system. The guest receives a key card, e.g., in the form of a magnetic card, or the like. It is also possible to use the guests own credit card or debit card as the key card.

When checking out, the guest uses the registration terminal 20, according to the present invention. The guest inserts the key card in the reading device 22a, and his/her name is displayed on the monitor 21. The guest can be requested to choose a language, e.g. Swedish, English, German or French. The bill related information is then displayed on the monitor 21, and the system 10 can ask for additional information, such as: (i) “Have you used the minibar?” If the guest has used the minibar, a list of the selectable items in the minibar is displayed on the monitor 21; (ii) “Have you used the hotel garage?” (iii) “Do you have a bonus card?” If the guest has a bonus card, he/she registers the card in the reading device 22a. Optionally this can be done automatically using the database mentioned above; and (iv) “Do you want to split the bill?” It is possible for the guest to, spilt the bill into, for example, private expenses and business/company related expenses.

The system 10 uses the bill related information, in form of the answers from the guest, for possible revision of the bill. The possible additional costs, minibar and/or garage, and so on, are added directly to the bill. The changed bill is viewed on the monitor 21.

Additional costs, such as an adapter rent, pay TV or the like, are registered in the booking system 50. These costs are automatically added to the bill. It is also possible to present, for example, bills from the restaurant, bar and the like for the guest's approval. The bills can be scanned or otherwise electronically presented.

A guest with a bonus card can sometimes receive a discount coupon, or the like. The discount coupon can, for example, give the guest an amount to spend in the restaurant or a free night or the like. The value of the discount coupon depends on the type of the bonus card, which in turn, may depend on how often the guest stays at the hotel. The system 10 automatically registers the present sum when the guest has registered his/her bonus card. If the guest has visited the restaurant, the amount of the discount is deducted from the bill. Instead of receiving a discount coupon the loyal guest can receive other awards like different types of offers, such as in the form of free nights and special offers.

The bill is accepted by means of, for example, a PIN-code related to the guest's credit card or bonus card, a signature on the monitor 21, a biometric signature or the like. It is also possible to use an electronic signature arrangement, e.g. an ePad™, or the like. The guest may at any time disapprove the bill and the automated checking out procedure, and personally complete it at the reception desk. If the guest accepts the bill, it is printed out by the printer 25a and a copy is sent to the reception. The printed bill is marked, “electronic approval”. The print-out also confirms, if the guest has a bonus card, that the loyalty program has registered the guest's bonus. Consequently the checking out procedure is completed.

It is further possible for the guest to check his/her bonus program account via the registration terminal 20. At many hotels, a certain amount of for example loyalty points are required to obtain a free night at the hotel, hence it can be interesting for the guest to be able to check his/her bonus status.

In another embodiment, the system 10 can be used as an information terminal for obtaining information, e.g., about the hotel, entertainment, communications, activities, maps and the like which can be displayed on the terminal screen. Different types of advertisement can also be offered.

In yet another embodiment, the guest can check out using a portable device, for example a laptop or a handheld computer, or PDA (Personal Digital Assistant) instead of using the registration terminal 20. A suitable interface can communicate with the internet connection of the hotel room wirelessly or via cable, and also store the bill.

The present invention has now been described in terms of preferred embodiment(s), as well as variations thereof. However, the invention is not limited to the illustrated embodiments, but variants and other modifications are also possible while still remaining within the scope of the claims.

What is claimed is:

1. A registration system, preferably for checking out a guest visiting a location, comprising:
at least one registration terminal;
a communication interface for communication with the guest;
a reading device, for reading an information carrier corresponding to a key information;
a communication arrangement, for communication with a booking system;
a compiling arrangement, for compiling a bill with information from the booking system;
a transaction means;
an information arrangement for providing bill related information to said guest; and
means for obtaining information from said guest for revising said bill with regard to the information from said guest.

2. The registration system as recited in claim 1, further comprising a registration arrangement configured for registration of loyalty points in a loyalty program.

3. The registration system as recited in claim 2, wherein said loyalty points provide a reward, in the form of one of (i) a discount coupon and (ii) another type of offer.

4. The registration system as recited in claim 2, wherein said registration terminal comprises a monitor, a reading device, a key pad, a computer and a printer.

5. The registration system as recited in claim 1, further comprising an arrangement for receiving information from the guest's credit card.

6. The registration system as recited in claim 1, further comprising a communication arrangement communicating with said booking system of the location.

7. The registration system as recited in claim 1, further comprising a communication arrangement communicating with a system handling the transactions of the location and the system handling the loyalty program database.

8. The registration system as recited in claim 1, wherein said information carrier is at least one of a room card, a bonus card and a credit card.

9. The registration system as recited in claim 8, wherein said room card and said bonus card are combined into a common card.

10. The registration system as recited in claim 9, wherein said common card is a credit card.

11. The registration system as recited in claim 1, wherein said bill is accepted through at least one of a pin code, a signature on said monitor and a biometric signature.

12. The registration system as recited in claim 11, wherein said bill is provided to a supervisor of the location at the same time as the guest receives a printed bill from said registration terminal.

13. The registration system as recited in claim 1, further comprising an information station.

14. The registration system as recited in claim 1, further comprising a computer as a portable device.

15. The registration system as recited in claim 1, further comprising an electrical signature registration device.

16. The registration system as recited in claim 1, further comprising means for splitting a bill into several parts.

17. The registration system as recited in claim 16, wherein said bill parts include at least one of a private part and a non-private part.

18. A method of checking out from a location, using a registration system, preferably for checking out a guest visiting a location, that includes (i) at least one registration terminal; (ii) a communication interface for communication with the guest; (iii) a reading device, for reading an information carrier corresponding to a key information; (iv) a communication arrangement, for communication with a booking system; (v) a compiling arrangement, for compiling a bill with information from the booking system; (vi) a transaction means; (vii) an information arrangement for providing bill related information to said guest; and (viii) means for obtaining information from said guest for revising said bill with regard to the information from said guest, said method comprising the steps of:
receiving identity information about the guest via said reading device (22a);
receiving bill related information from the guest; and
using said bill related information from the guest for possible revision of said bill.
